(19) United States
(12) Patent Application Publication
(10) Pub. No.: US 2005/0182674 A1
(43) Pub. Date: Aug. 18, 2005

(54) Charge approval and payment system

(76) Inventor: Tae Soon Yeo, Yeoju (KR)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/513,046

(22) PCT Filed: Apr. 29, 2003
(86) PCT No.: PCT/KR03/00861

(30) Foreign Application Priority Data
Apr. 29, 2002 (KR) 10-2002-0023509

(51) Int. Cl. G06F 17/60

(52) U.S. Cl. 705/13

(57) ABSTRACT

A charge settlement system is capable of settling a charge, even during movement, without access to any card-inquiry terminal such as a magnetic credit card. The system is relatively inexpensive to construct and includes a transaction terminal and a portable wireless settlement device. When the transaction terminal requests a payment to the portable wireless settlement device via a communication network, the portable wireless settlement device accesses a server via a wireless communication network for settlement. The portable wireless settlement device includes wireless communication with a transaction terminal; a button section for payment and receipt; a key-entering section; a display device for displaying various kinds of information; and a controller having various types of data stored therein. Payment information is transmitted on a payment mechanism to the transaction terminal, and a payment-confirmation signal is transmitted for payment and receipt, to the transaction terminal via the wireless communication.

### FIELD OF THE INVENTION

The present invention relates to a charge settlement system, and more particularly to a charge settlement system capable of settling a charge, even during movement, without access to any card-inquiry terminal as in the case of a magnetic credit card; the system also being relatively inexpensive to construct.

### RELATED BACKGROUND ART

As generally known in the art, when a charge is settled using a magnetic credit card, the card should be accessed by or pass though a card-inquiry terminal in order to read the information stored on the magnet of the card. When the card-inquiry terminal has read out the information stored on the magnet, the terminal sends an approval request to the credit card company's server. Then, the server reads and checks the information and transmits approval information to the terminal. Based on the approval information, the terminal settles the charge and prints a receipt.

Of course, the information stored on the magnet may include a password and various kinds of information recorded when the card was first issued. The information then forms the basis of identifying the card user and checking the approval request.

However, the magnetic card settlement system has a problem in that no settlement is possible during movement. That is to say, the card user must carry the card always and submit it so that a person moves the card through a card-inquiry terminal for approval. Since the magnetic card is a contact-type, the user must stop where the card-inquiry terminal is installed to use the card. This greatly limits the usability of the magnetic card very much.

Furthermore, when a magnetic card or an IC card is used, it must contact or pass through a card-inquiry terminal. This can often cause damage (e.g., damage by magnetic field, physical wear) to the magnet of the card. If the card is damaged, it can not be used any more. Moreover, it takes a lot of time and expense to reissue the card.

### SUMMARY OF THE INVENTION

Accordingly, the present invention has been made to solve the above-mentioned problems occurring in the prior art, and an object of the present invention is to provide a charge settlement system capable of settling a charge at a relatively long distance (about 100 m or more), even during movement, without bringing a card into contact with any card-inquiry terminal.

In order to accomplish this object, there is provided a charge settlement system having a portable wireless settlement device adapted to pay a charge by means of a wireless terminal in accordance with a payment request from a transaction terminal occurring during various transactions.

The transaction terminal consists of a controller installed on a wireless terminal adapted to process the payment of, e.g., goods, services or tolls. The controller transmits a payment-requesting signal by means of encrypted wireless data for wireless communication with the portable wireless settlement device. When the controller receives payment information from the portable wireless settlement device, it identifies the payment means and conducts a determined procedure.

The portable wireless settlement device comprises a wireless encrypted-data communication unit for communication with the wireless communication means of the transaction terminal, a button section for payment and receipt, a key-entering section, a display device section for displaying various kinds of information, and a controller. The controller has various kinds of information stored therein on individually encrypted data for payment. When a payment-requesting signal is received from the transaction terminal through the wireless communication means, the controller displays the signal through an LCD device. If a payment means is chosen through the key-entering means, the controller transmits the information on the payment means as wireless encrypted-data. Thereafter, the transaction terminal requests a payment confirmation. The request is then displayed on the display device. Finally, when the user confirms the payment through the button section for payment and receipt, a payment-confirmation signal is transmitted to the transaction terminal through the individually encrypted wireless communication means under control of the controller.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic diagram showing a charge settlement system according to the present invention;

FIG. 2 is a block diagram showing the configuration of a portable wireless settlement device shown in FIG. 1;

FIG. 3 is a flow chart showing the operation of the portable wireless settlement device shown in FIG. 2;

FIG. 4 is a flow chart showing the operation of a transaction terminal shown in FIG. 1;

FIG. 5 is a flow chart showing a settlement procedure using a credit card according to the charge settlement system of the present invention; and

FIG. 6 is a schematic diagram showing an expressway toll collection system applying a charge settlement system according to the present invention.

### DESCRIPTION OF THE PREFERRED EMBODIMENTS

Hereinafter, a preferred embodiment of the present invention will be descried with reference to the accompanying drawings. In the following description and drawings, the same reference numerals are used to designate the same or similar components, and so repetition of the description on the same or similar components will be omitted.

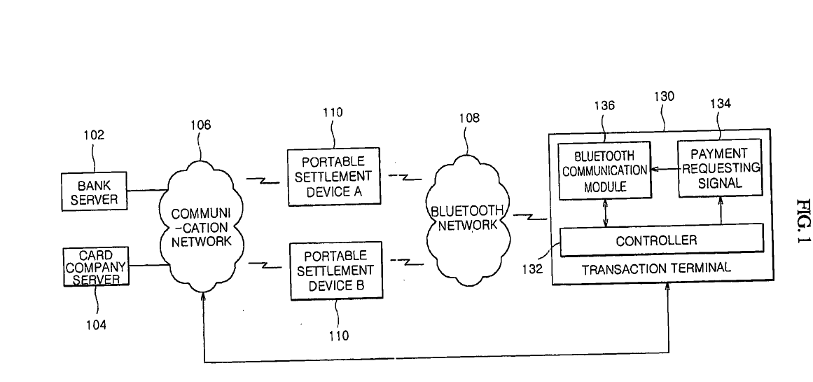

As shown in FIG. 1, a charge settlement system according to the present invention comprises a bank server 102, a card company server 104, a plurality of portable wireless settlement devices 10, and a transaction terminal 130. A communication network connects the portable wireless settlement devices 110 with the bank server 102 and the card company server 104. A Bluetooth network 108 connects the portable wireless settlement devices 10 with the transaction terminal 130.

Referring to FIG. 1, when the bank server 102 or the card company server 104 receives a settlement-requesting signal from the portable wireless device 10 or the transaction terminal 130 via the communication network 106, it performs authentication. If the transaction is justified, a settlement is approved. Then, the approval data (e.g., approval number and the amount of approved money) is transmitted to the portable wireless settlement device 110 or the transaction terminal 130. The communication network 106 is either a wire communication network or a wireless communication network, including a wired/wireless Internet.

The transaction terminal 130 is installed, for example, at a vending machine, a taxi, a bus, a subway, an expressway toll collection system, or a restaurant. It may have a Bluetooth communication module 136 for Bluetooth-mode communication with the portable wireless settlement device 110. During a transaction, it transmits a payment-requesting signal 134, including transaction particulars, membership number of the store, etc., to the portable wireless settlement device 110 under control of the controller 132 for requesting a payment. When payment information is received from the portable wireless settlement device 110, the information is processed. If a credit card is used for payment the transaction terminal 130 accesses a credit card company server 102 or a payment gateway (not shown) via the communication network 106 and requests that the transaction request be approved. If the transaction request is approved, the transaction terminal 130 requests the portable wireless settlement device 110 to confirm a payment. Finally, the transaction is completed by the payment confirmation. The transaction terminal 130 may be implemented by adding a controller 132 and a Bluetooth communication module 136 to an existing terminal, such as card-inquiry terminal or a cash register. Although a Bluetooth communication network 108 is adopted for the communication between the portable wireless settlement device 110 and the transaction terminal 130 in this embodiment other wireless communication networks may also be used.

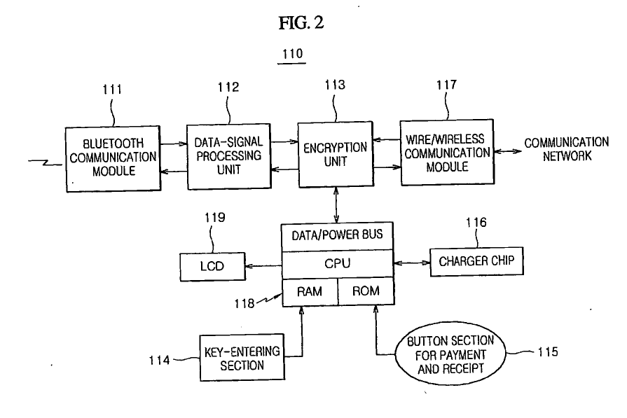

As shown in FIG. 2, the portable wireless settlement device 110 comprises a Bluetooth communication module 111, a data-signal processing unit 112, an encryption unit 113, a key-entering section 114, a button section for payment and receipt 115, a charger chip 116, a wired/wireless communication module 117, a controller 118, and an LCD 119. The portable wireless settlement device 110 can communicate with the transaction terminal 130 via the Bluetooth communication module 111, as well as with the servers 102, 104 via the wired/wireless communication module 117. The controller 118 comprises a CPU, a ROM, a RAM, a flash memory, and a data/power bus. The controller 118 controls the overall operation in accordance with the software installed in the memory. When a person carries the portable wireless settlement device 110, he/she can perform wireless communication in the range of 100-200 m, as well as settle a charge quickly, because of the characteristics of the Bluetooth. Accordingly, he/she is able to not only stop at a vending machine and settle a charge, but also pay a toll during movement at an expressway toll collection system. Meanwhile, the portable wireless settlement device 110 is provided with a card number and a separate authentication number (encrypted) by a credit card company, as a credit card is issued. The authentication number is used for communication authentication with the card company server 104.

Referring to FIG. 2, the Bluetooth communication module 111 provides communication with the Bluetooth communication module 136 of the transaction terminal 130. The data-signal processing unit 112 provides the controller 118 with the data received from the Bluetooth communication module 111 and then receives an approval from the controller 118. The memory of the controller 118 has various kinds of information stored therein, such as an authentication number of the portable wireless settlement device 110 and a card number of a user.

The wired/wireless communication module 117 is adapted to access the card company server 104 or the bank server 102 via a wire or wireless communication means (e.g., an internet network) and provide the controller 118 with information, such as approval information. The button section for payment and receipt 115 is connected to the controller 118 and makes it possible to pay an amount of money upon receiving approval information via the wired/wireless communication module 117.

The encryption unit 113 is connected between the data-signal processing unit 112 and the controller 118. The encryption unit 113 encrypts the data transmitted between the transaction terminal 130 and the portable wireless settlement device 110, as well as between the portable wireless settlement device 110 and the servers 102, 104. The key-entering section 114 is used to enter a password, which is set by the user for security, or other operations. The wired/wireless communication module 117 is provided with an antenna for smooth wireless communication Although not shown in the drawings, an additional means may be used for identifying the fingerprint or iris of a user for authentication.

The password is set and entered by means of numeric buttons of the key-entering section 114 to prevent other persons from using the portable wireless settlement device 110. That is, once a password is set in the controller 118 through the numeric buttons of the key-entering section 114, other persons cannot use the portable wireless settlement device 110, because the same password must be entered to make the controller 118 control the Bluetooth communication module 111.

A compact LCD 119 is provided to display operating conditions or various kinds of information (e.g., an approval request, the amount of money requested for approval) transmitted to the controller 118. The user can check the amount of money through the LCD 119 before approving a payment and then press the payment button 115.

The charger chip 116 is connected to the controller 118 and has an amount of money charged previously, as in the case of a charger chip used in a charger-type card. If the charger chip 116 has a sufficient amount of money charged, the money can be used for settlement without access to the card company server 104 when the transaction terminal 130 requests a payment. In other words, when the charger chip 116 has an amount of money charged from the bank server 102, the charged money can be used for payment/settlement. If the charged money is depleted, the charger chip 116 can be recharged with money from the bank server 102 for further use.

Of course, the charger chip 116 is used not only as a settlement means but also for a Peer to Peer (P2P) financial transaction between persons carrying the portable wireless settlement devices 110.

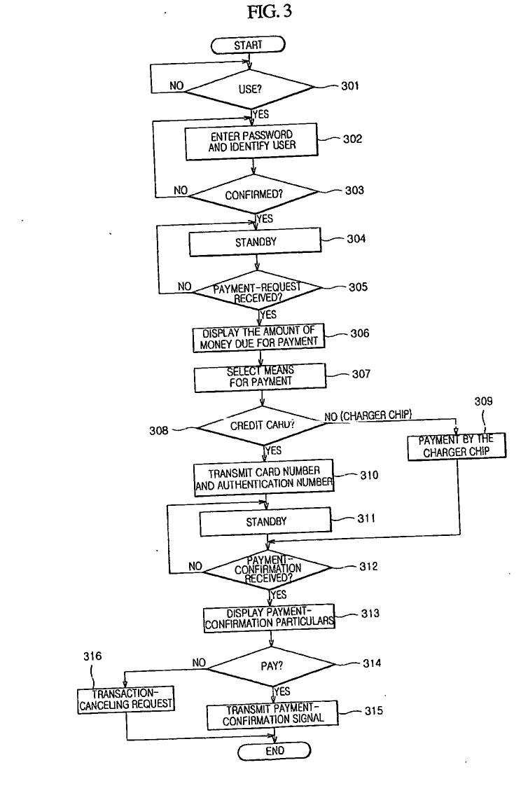

The operation of the portable wireless settlement device configured as above will now be described with reference to FIG. 3.

When the portable wireless settlement device 110 is needed for payment at a vending machine or for paying a toll or the like, a password must be entered using the key-entering section 114 (steps 301, 302). The password is set by a user initially, and is used to prevent other persons from using the portable wireless settlement device 110 illegally.

The controller 118 compares the entered password with the already-set password. If they are proven to be the same, the controller 118 operates the Bluetooth communication module 111 and waits for a payment-requesting signal from the transaction terminal 130 (steps 303, 304).

If the payment-requesting signal is received from the transaction terminal 130 via the Bluetooth communication module 111, the amount of money due for payment is displayed through the LCD 119. Then, the user chooses a payment means by means of the key-entering section 114 (steps 305 to 307). Although various types of payment means, e.g., a credit card, a prepaid card, a charger chip, and a fund transfer, may be used, a payment by a credit card and a charger chip is illustrated in this embodiment When there are a number of credit cards, the user can select one for settlement using the key-entering section 114.

When the user selects a specific credit card, the encryption unit 113 encrypts information needed for settlement, such as a card number stored in the memory and an authentication number. The encrypted information is then transmitted to the transaction terminal 130 via the Bluetooth communication module 111. If the user selects a charger chip, the charger chip 116 is used for payment (steps 308 to 310).

After a standby, if a payment-confirmation signal is received form the transaction terminal 130, the payment-confirmation particulars are displayed through the LCD 119 (steps 311 to 313). The payment-confirmation particulars include an approval number, an amount of money approved, in the case of a credit card, and any other transaction particulars.

The user can confirm the payment by means of the button section for payment and receipt 115. Then, a payment-confirmation signal is transmitted to the transaction terminal 130 via the encryption unit 113, data-signal processing unit 112, and the Bluetooth communication module 111 (steps 314, 315). The user can also cancel the payment by not operating the button section for payment and receipt 115 (step 316). Alternately, an additional key for canceling the payment may be provided on the key-entering section 114. If the transaction terminal 130 receives the payment-confirmation signal from the portable wireless settlement device 110, the transaction is completed and necessary measures are taken.

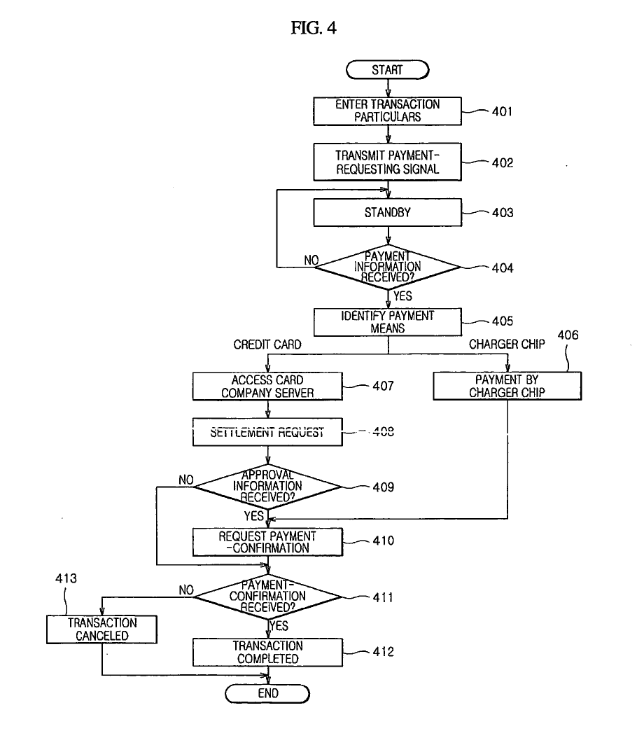

FIG. 4 is a flow chart illustrating the operation of the transaction terminal shown in FIG. 1.

Referring to FIG. 4, transaction particulars are entered first (step 401). In the case of a vending machine, the transaction particulars are entered when the user chooses a desired item. In the case of a restaurant a clerk enters the transaction particulars acceding to the user's order.

Then, a payment-requesting signal, including the amount of money, is transmitted to the portable wireless settlement device 110 via the Bluetooth communication module 136 in accordance with the transaction particulars. Thereafter, the transaction terminal waits for payment information from the portable wireless settlement device 110 (steps 402 and 403).

If payment information is received from the portable wireless settlement device 110, the information is analyzed and a payment means is determined (steps 404, 405). In the case of a payment by a credit card, the transaction terminal accesses the corresponding card company server 104 and transmits settlement information received from the portable wireless settlement device 110, including a card number, an authentication number, and transaction particulars (e.g., the amount of money, membership number of the store) for requesting authentication and settlement (steps 407, 408). The card company server 104 checks the authentication and the transaction particulars to approve or reject the transaction.

If the transaction is approved, approval information (e.g., an approval number and the amount of money approved) is received from the card company server 104. The transaction terminal 130 retransmits the information to the portable wireless settlement device 110 to request a payment-confirmation (step 410). The payment confirmation information is displayed on the LCD 119. The user then checks particulars and decides whether to pay or not.

If payment-confirmation signal is received from the portable wireless settlement device 110, the transaction terminal 130 completes the transaction. If the signal is not received or a transaction-canceling signal is received, the transaction is canceled (steps 411 to 413).

Meanwhile, if a payment by a charger chip is selected from the portable wireless settlement device 110 in step 405, a determined procedure is performed (step 406) for the payment by a charger chip.

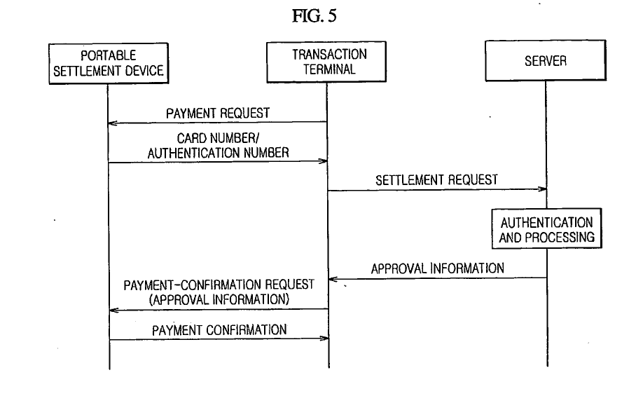

FIG. 5 is an overall flow chart showing the settlement procedure using a credit card according to the charge settlement system of the present invention.

The transaction terminal 130 transmits a payment-requesting signal to the portable wireless settlement device 110 in accordance with the transaction particulars. The portable wireless settlement device 110 displays the information regarding the amount of money, included in the payment-requesting signal, for the users choice of a payment means. For example, if the user wants to choose a payment by a credit card, he/she presses a button numbered \mathring{1} in the key-entering section 114. If he/she wants to choose a payment by a charger chip (pre-paid type), he/she presses a button numbered \mathring{2}.

When a credit card is selected for payment, the portable wireless settlement device 110 encrypts already-stored information necessary for settlement such as a card number and an authentication number, and transmits the encrypted information to the transaction terminal 130 via the Bluetooth communication module 111.

The transaction terminal 130 then adds the transaction particulars and a membership number of the store, etc., to the card number and the authentication number and transmits a settlement-requesting signal to the card company server 104. The card company 104 verifies the settlement request based on the received information. If the transaction is verified, the card company server 104 transmits approval information to the transaction terminal 130 including an approval number and the amount of money approved. The transaction terminal 130 then requests the portable wireless settlement device 110 that the payment be confirmed. The payment-confirmation request includes the approval number and the amount of money approved. Finally, the user checks the approval number and the amount of money and then approves the payment by operating the button section for payment and receipt 115.

### EXAMPLE 1

### Application to a Vending Machine

An example will now be described in the case where the above-mentioned portable wireless settlement device 110 is used to operate a transaction terminal 130 installed on a vending machine.

When a person carries a portable wireless settlement device 110, which is in cooperation with a card company, he/she can purchase an item by pressing a corresponding button on the vending machine.

When a button is pressed, an order signal is transmitted to a controller 132. The controller 132 then transmits a payment-requesting signal to a Bluetooth communication module 111 of the portable wireless settlement device via a Bluetooth communication module 136.

The Bluetooth communication module 111 transmits the payment-requesting signal to a controller 118 via a data-signal processing unit 112 and an encryption unit 113.

The controller 132 of the transaction terminal 130 sends information on the price of the selected item. The price is displayed on an LCD 119 by means of the controller 118 of the portable wireless settlement device.

The user now can select a means for payment.

If a credit card is selected for payment, the controller 118 encrypts the already-stored card number and the authentication number at the encryption unit 113 and transmits the encryption to the transaction terminal 130 via the data-signal processing unit 112 and the Bluetooth communication module 111. The transaction terminal 130 accesses a card company server 104 via a communication network 106 through a wire/wireless communication module (not shown) for requesting a settlement.

When the card company server 104 completes an authentication process, it sends an approval number and the amount of money approved via a wire/wireless communication module (not shown). The transaction terminal 130 retransmits them to the portable wireless settlement device 110 for requesting a payment-confirmation.

The user checks the received approval information and presses a payment button 115 for payment. The Bluetooth communication module 111 then transmits payment-confirmation information to the Bluetooth communication module 136 of the transaction terminal via the encryption unit 113 and the data-signal processing unit 112. Finally, the controller 132 of the transaction terminal 130 operates the vending machine to send the desired item out.

### EXAMPLE 2

### Application to a Restaurant Transaction

Application to a case where a separate card-inquiry terminal is installed, as in a restaurant, is similar to the above-mentioned Example 1. First, the card-inquiry terminal is provided with a Bluetooth communication module 136 and a controller 132 for transmitting a settlement-requesting signal or an order signal to a portable wireless settlement device.

The clerk of the restaurant enters the amount of money due for settlement using the transaction terminal and transmits the information to the portable wireless settlement device 110 via the controller 132 and the Bluetooth communication module 136. The portable wireless settlement device 110 then displays the approval information on its LCD. The user now can settle the charge by operating the payment button 115.

### EXAMPLE 3

### Application to an Expressway Toll Collection System

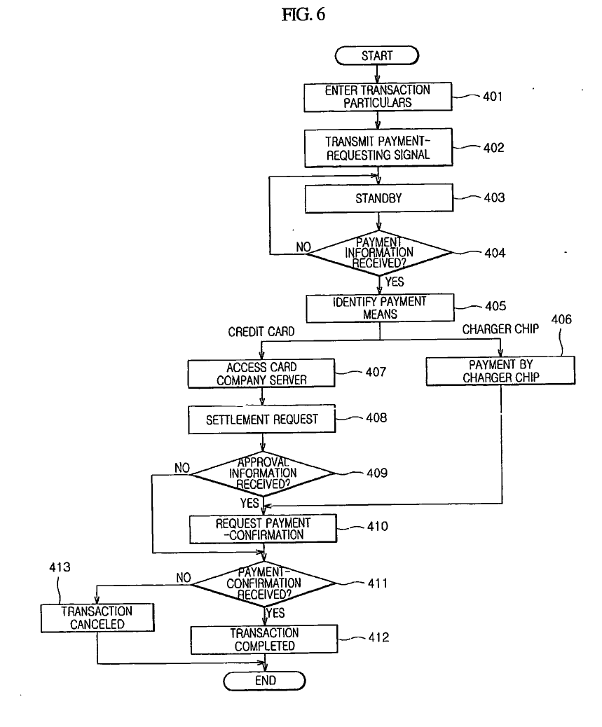

An important application of the charge settlement system of the present invention is directed to a settlement procedure during movement. Accordingly, an application to an expressway toll collection system will now be described with reference to FIG. 6.

Referring to FIG. 6, an expressway toll collection system comprises tollgates T positioned at the entrance and the exit of an expressway, sub-computers SUB installed at the tollgates T, Bluetooth communication modules 1-1 to 1-n connected to the sub-computers, a main computer 610 of the road managing authority for connecting the sub-computers in a centrally-concentrated manner, and servers 630 of various financial institutions connected to the main computer 610 via a wired/wireless communication network 620. The vehicles passing on the road are provided with the portable wireless settlement devices 110 of the present invention.

Particularly, the sub-computer SUB is provided with a separate Bluetooth communication module 1-n at a relatively distant location from a tollgate T. The separate module 1-n detects an approaching vehicle before it enters the tollgate T and informs the sub-computer SUB of the approach. This facilitates various operations, such as an approval request and a settlement. In general, when a vehicle enters a tollgate T with a speed the Bluetooth communication modules 1-1, 1-n communicate with the vehicle instantly and request a settlement. The driver can settle a toll quickly by operating a payment button 115. Specifically, the separate Bluetooth communication module 1-n communicates with the portable settlement device 110 of the vehicle driver beforehand and transmits a settlement-approving request and a payment-requesting signal. The driver can settle a toll easily without any delay by operating the payment button 115 near the tollgate T.

For example, when a vehicle equipped with the portable wireless communication device 110 of the present invention enters an entrance tollgate T of an expressway, the entrance information is transmitted to the Bluetooth modules 1-1 to 1-n positioned at the entrance tollgate T and the sub-computers SUB. The information is reported to the main computer 610 and monitored. When the vehicle approaches an exit tollgate T for exiting the expressway, a toll is calculated based on the travel information. At the same time, the sub-computer SUB at the exit tollgate T transmits payment-requesting signal to the portable wireless settlement device 110 via the Bluetooth modules 1-1 to 1-n. If the driver selects a payment means, as described above, the payment information is transmitted to the sub-computer SUB. The sub-computer SUB transmits a settlement-requesting signal to the server 630 of a financial institution via the main computer 610 and the wire/wireless communication network 620. Since the remaining procedure for settlement is the same as the above-mentioned case, detailed explanation thereof will be omitted.

Although a preferred embodiment of the present invention has been described for illustrative purposes, those skilled in the art will appreciate that various modifications, additions and substitutions are possible, without departing from the scope and spirit of the invention as disclosed in the accompanying claims.

As explained above, the charge settlement system of the present invention can be used as a settlement means in a variety of commercial transactions, such as for a vending machine, a travel fee payment system for a bus or a taxi, and an expressway toll collection system. According to the present invention, it is possible to settle a charge without contact type, not only during staying at a fixed location but also during movement by installing a portable wireless communication settlement device comprising a Bluetooth communication module and a wire/wireless communication module capable of performing a wireless communication with a card company server and a bank server, as well as a transaction terminal comprising a Bluetooth communication module in communication with the Bluetooth communication module of the portable wireless communication module.

1. A charge settlement system comprising a transaction terminal for calculating the expenses occurring during various transactions and a portable wireless settlement device for processing payments according to payment requests of the transaction terminal, wherein
the transaction terminal comprises:
a wireless communication means installed on a terminal adapted to process a charge for goods or services or a toll, the wireless communication means performing wireless communication with the portable wireless settlement device; and
a controller configured to transmit a payment-requesting signal, including transaction particulars, to the wireless communication means and, when payment information is received from the portable wireless settlement device, identify a payment means for performing a determined procedure, and
the portable wireless communication means for communication with the wireless communication means of the transaction terminal;
a button section for payment and receipt;
a key-entering section;
a display device for displaying various kinds of information;
a charger chip for charging an amount of money for settlement beforehand;
a wire/wireless communication module for accessing a server via a communication network in order for the charger chip to be charged with an amount of money; and
a controller having various types of data stored therein, the controller controlling the display device to display the payment-requesting signal received from the transaction terminal, transmitting payment information on a payment means chosen by the key-entering section to the transaction terminal, making the display device display a payment-confirmation request from the transaction terminal, and transmitting a payment-confirmation signal, entered by the button section for payment and receipt, to the transaction terminal via the wireless communication means, the controller controlling the charged money to be used for settlement if a payment-requesting signal is received from the transaction terminal and the charged money in the charger chip is sufficient for settlement, controlling the access to the server via wire/wireless communication module so that the charger chip is charged with an amount of money if the charged money in the charger chip is depleted.

2. The charge settlement system as claimed in claim 1, wherein the portable wireless settlement device comprises a data-signal processing unit connected to the wireless communication means for data-processing and an encryption data-signal processing unit connected to the data-signal processing unit, so that the individual data transmitted between the controller and the transaction terminal is encrypted for the individual user, and an additional ASIC encryption unit is provided for a correct transaction as well as for a hacking-prevention.

3. The charge settlement system as claimed in claim 1, wherein the portable wireless settlement device uses the key-entering section to set and enter a password, and further comprises a biomatics means for user authentication.

4. The charge settlement system as claimed in claim 1, wherein the wireless communication means is a Bluetooth communication module or a wireless communication module.

5. (canceled)

6. (canceled)

7. A charge settlement system comprising a transaction terminal and a portable wireless settlement device, wherein
the transaction terminal includes:
a Bluetooth communication module installed on a terminal adapted to pay a charge occurring when purchasing goods or a toll, such as at a vending machine, a taxi, a bus, a subway, an expressway toll collection system; and
a first controller for providing the Bluetooth communication module with an order signal and a payment-requesting signal, and
the portable wireless settlement device includes:
a Bluetooth communication module for communication with the Bluetooth communication module of the transaction terminal;
a second controller;
a data-signal processing unit for providing the second controller with a data transmitted to the Bluetooth communication module and receiving an approval from the second controller;
a memory for storing information, such as an approval number of the portable wireless communication device and the user's card number, to provide the second controller with the information;
a charger chip connected to the second controller for providing a payment-requesting/payment-approval signal, the charger also being able to be charged with an amount of money through connection with a bank server;
a payment button connected to the second controller, the payment button enabling an amount of money to be paid upon receiving a payment approval from the charger chip and the second controller; and
a display device connected to the second controller for displaying the amount of money approved and the approval number or the like.
